(19) United States
(12) Patent Application Publication
(10) Pub. No.: US 2020/0370360 A1
(43) Pub. Date: Nov. 26, 2020

(54) MOBILE INTERFACE UNIT

(71) Applicant: Lowe Rental Ltd, Lisburn (GB)

(72) Inventor: Rodney Lowry, Lisburn Antrim (GB)

(21) Appl. No.: 16/770,762

(22) PCT Filed: Nov. 15, 2018
(86) PCT No.: PCT/GB2018/053314

§ 371 Date: Jun. 8, 2020

(30) Foreign Application Priority Data
Dec. 6, 2017 (GB) 1720362.1

(51) Int. Cl. E05G 1/00; F25D 23/02; G06F 3/041; G06F 3/14; E05G 1/10; A47G 29/20; A47G 29/30

(52) U.S. Cl. CPC E05G 1/005; F25D 23/028; G06F 3/041; F25D 2400/361; E05G 1/10; A47G 29/20; A47G 29/30; G06F 3/1423

(57) ABSTRACT

The present invention relates to a mobile interface unit (2) comprising at least one temperature controlled cabinet (4), a refrigerator door (6) to provide access to the cabinet, and refrigeration apparatus to provide refrigeration to the cabinet, the unit further comprising a safe (80) and one or more display screens (40, 45).

The present invention relates to a mobile interface unit, and more particularly to such an interface unit that incorporates a refrigerator unit.

In this respect, mobile refrigerators are known in the art, and they are generally intended to provide a refrigerator able to be used in a temporary location such as exhibition stands and the like. Promotors and exhibitors generally create a temporary stand or exhibition area, and may wish to include a suitable refrigerator for storing refreshments, particularly beverages, for customers. There is a substantial market in supplying suitable mobile refrigerators for such purposes, which can then be re-used and re-allocated quickly for other exhibitions or temporary structures.

Where an exhibition stand has a number of dedicated staff, then the exhibition stand may be able to be safely manned at all times, and any refrigerator may be part of a larger arrangement of other units or parts of the stand. Although, even a well-manned stand can be at times under ‘high occupancy’, along with visiting companies or site staff that do not belong to the stand, and who could potentially commit an act of theft to personal or company belongings. Moreover, competing companies could gain access to contract sensitive information or belongings.

Where an exhibition stand may only be manned by a single person, or a low number of personnel, there can be times when no personnel can attend or be next to the exhibition stand, such that it is deemed ‘empty’. At that time, there is no secure location for the exhibitors' personal effects, information or valuables.

Thus, according to one aspect of the present invention, there is provided a mobile interface unit comprising at least one temperature controlled cabinet, a refrigerator door to provide access to the cabinet, and refrigeration apparatus to provide refrigeration to the cabinet, the unit further comprising a safe and one or more display screens.

In this way, the mobile interface unit can provide the expected refrigerated function for contents in a refrigerated cabinet. It can also provide a conjoining safe, able to store personal effects, information and valuables, etc., the combined unit not being easily removable by a thief, as well as one or more display screens for communicating and interfacing with people in the vicinity of the unit.

At least one of the one or more display screens is preferably a touch screen. It may be conveniently provided on a substantially horizontal surface of the unit. For example, the one or more display screens preferably take the form of a touch screen that extends across a top surface of the unit. Such a screen may be used to fill in personal details of visitors to the unit and preferably has a narrow viewable angle. This may conveniently be provided by way of a privacy screen filter.

The one or more display screens may be moulded or otherwise securely fixedly integrated into the exterior of the unit, so as deter unauthorised removal, or may be releasably docked into the exterior surface of the unit by way of a secure docking connection. In the latter case, the safe may be provided with one or more slots for stowing the one or more screens when not in place on the exterior of the unit.

Preferably, the docking connection comprises a power connection.

The one or more display screens may further preferably comprise a front screen mounted on a substantially vertical face of the unit, preferably a front face. Conveniently, the front screen may be integrated into the refrigerator door in a portrait configuration. Such a front mounted screen may be used to communicate information to one or more visitors in the vicinity of the unit and may conveniently have a wide viewing angle so as to be viewable by multiple visitors located around the unit.

The interface unit may incorporate one or more cameras and microphones, enabling the unit to be used for video conferencing applications.

The interface unit may further comprise a wireless charging capability. The wireless charging capability is preferably offered through suitable charging pads mounted on the exterior of the unit requiring devices to be charged being placed on the pad, or through a charging transmitter to charge adjacent devices.

Each of the one or more screens preferably has one or more of USB, Bluetooth or wireless connectivity.

In this regard, the unit is preferably configured to be readily networked into a protected local network, such as that of an exhibition centre. Such a network may, for example, comprise an alarm network, whereby alarm conditions can be readily communicated to the unit with, for example, evacuation instructions being communicated through one or more of the one or more display screens. The unit is preferably provided with transmitter/receiver means enabling communication with such local networks.

The unit may further comprise a scanner for scanning, for example, QR codes or bar codes on a visitor's pass, or for scanning business cards into an appropriate directory. Consequently, business cards need not be left at the unit, reducing the risk of information theft.

The interface unit may in this respect be linked to a Native App, so that information can be gathered relevant to visitor location, their preferences and hub locations, thereby optimising information displayed on the one or more screens of a unit, whilst a visitor is in the vicinity of that screen, and optimising collection of visitor behaviour data for subsequent analysis. Where a number of such units are deployed, they can be linked to each other to further optimise the information gathered.

The term “mobile” as used herein relates to the interface unit being generally transportable from one location to another when required. This may include the use of one or more wheels, castors or the like to allow easy movement along suitable surfaces for the interface unit, which wheels or apparatus or castors may be lockable when the interface unit is intended to be located in a fixed position, typically at an exhibition stand, for a period of time.

The present invention is not limited to having wheels or castors, and the mobile interface unit may be designed to be easily transportable using one or more additional devices such as a trolley or jack, or to have or to use a separable set of wheels or castors in the form of a bogey or other suitable undercarriage.

The interface unit of the present invention has a temperature controlled cabinet, generally being at a temperature lower than ambient, such as below 10° C., typically in the range 4-6° C. The temperature achieved in many refrigerators, especially for the provision of potable liquids, is well known in the art.

The refrigeration apparatus has refrigeration apparatus to provide refrigeration to the cabinet, typically involving at least a pump, compressor and heat release unit. The parts and operation of suitable refrigeration apparatus able to provide refrigeration to a cabinet are well known in the art, and are not further described herein.

The interface unit includes a refrigerator door, to provide access to the cabinet. The door is typically hinged on one side, and provides part, substantial or full access along one side of the cabinet, to the contents therein. Typically, the door includes a seal, and a handle, in a manner known in the art.

Optionally, the refrigerator is lockable.

The term “safe” as used herein relates to a secure and contained space, generally formed of a number of walls considered to be wholly or substantially impenetrable for a pre-determined or defined period of time within the expected standard of the safe.

The mobile interface unit may include one or more portals to provide access to the inside or contents of the safe.

Optionally, the mobile interface unit includes a door to provide access to the inside or contents of the safe, and the safe includes one or more means able to secure the door to the walls or other part of the safe, so as to provide a secure enclosure, not openable without the relevant ‘key’.

Keys to open a safe portal or door can be physical, or electronic or both, and are well known in the art. Some keys relate to including a passcode, password, or passkey, and/or the input of one or more alpha-numeric numerals on a keypad located on the outside of the safe, often but not limited to being located on the door. In the case of an electronic key, users of the unit may be issued with unique identifier pass codes, so that details of access into the safe and/or refrigerator can be logged. Such pass codes can be issued remotely when required and can be programmed to allow access for different people within specific time periods, such as for example the duration of a particular exhibition for an exhibitor, or pre-exhibition for restocking requirements.

Typically, the safe includes a locking mechanism between a side or end of the door and a part of the safe, which opening mechanism is released by operation of the relevant key or correct application of the required password or passcode etc.

In one embodiment of the present invention, the safe is wholly or substantially located within the cabinet. Optionally, the safe has a lockable safe door separate to the refrigerator door, to provide access to the safe.

In another embodiment of the present invention, the safe has defined walls separate from the refrigerated cabinet.

In another embodiment of the present invention, the safe is wholly or substantially separate from the cabinet. Optionally, the safe has a lockable safe door separate to the refrigerator door, to provide access to the safe.

Optionally, the safe and the cabinet are housed in an outer housing, providing a single housing for both. Optionally, the outer housing has an outer housing door, able to provide access to at least a refrigerated door and optionally a lockable safe door. Optionally, the outer housing door is lockable.

The mobile interface apparatus may have any suitable dimensions, including but not limited to a width of at least 200 cm, such as 500 cm, optionally greater than 1 m, a height of at least 500 cm, such as 900 cm, optionally greater than 1 m, and a length of at least 200 cm, such as 500 cm, optionally greater than 1 m.

Optionally, the interface refrigeration apparatus has a flat top surface, which surface is able to provide a suitable surface for use as part of an exhibition stand.

Typically, the mobile interface unit is powered by single phase 13 amp mains electricity, but the invention is not limited thereto.

Optionally, the mobile interface apparatus of the present invention further includes one or more power or recharging sockets, stations or bases. Such sockets etc. may be for the provision of power to one or more separate items, including but not limited to items requiring low level power, medium level power and/or higher power.

In one embodiment of the present invention, the one or more power or recharging sockets, stations or bases include one or more from the groups comprising: single phase power sockets, USB outlets, wired charging pads, and wireless charging pads.

In another embodiment, the power sockets etc. include one or more sockets or bases to provide power to a phone or tablet or computer, laptop or other digital device known in the art.

Optionally, the unit further includes a tracking device. The tracking device may have any suitable size, shape design, design, and may be overt or covert. The tracking device can be linked to a tracking unit or station, and assist location of the unit should the unit be moved without expectation, e.g. stolen.

Preferably, the interface unit may have one or more accelerometers and/or gyro sensors for detecting if the unit is being moved. If movement is detected at a time when this is not anticipated above a threshold level, then a suitable alarm signal and/or notification can be activated. The unit may in this regard have a means for programming appropriate moving times and/or status. The status of the interface unit may in this regard be set remotely, so that for example the unit can be moved to an alarmed status when positioned on a stand, such that unauthorised subsequent movement will activate an alarm signal. In the event of an unauthorised movement, the one or more cameras and/or microphones may be enabled to record.

Optionally, the unit may further include one or more of: a table top folding leaf, a freezer, a LED front screen, a coffee maker and a microwave.

According to a further aspect of the present invention there is provided a plurality of units as defined above, linked together to share visitor preference information, the one or more display screens on said units being configurable to display information relevant to the visitor preferences.

Embodiments of the present invention will now be described by way of example only, and with reference to the accompanying drawings in which:

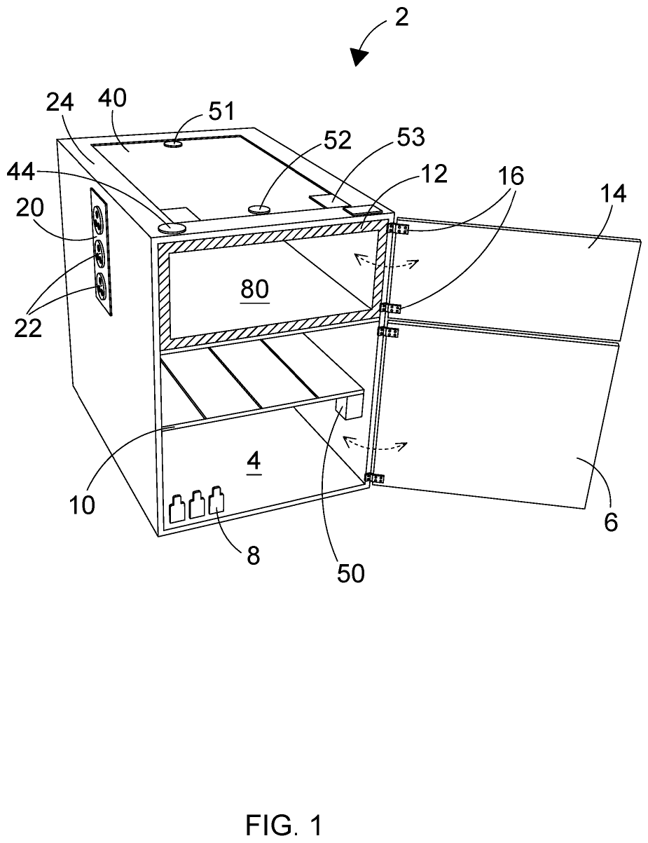

FIG. 1 is a perspective view of a mobile refrigerator unit according to one embodiment of the present invention showing two doors in an open position;

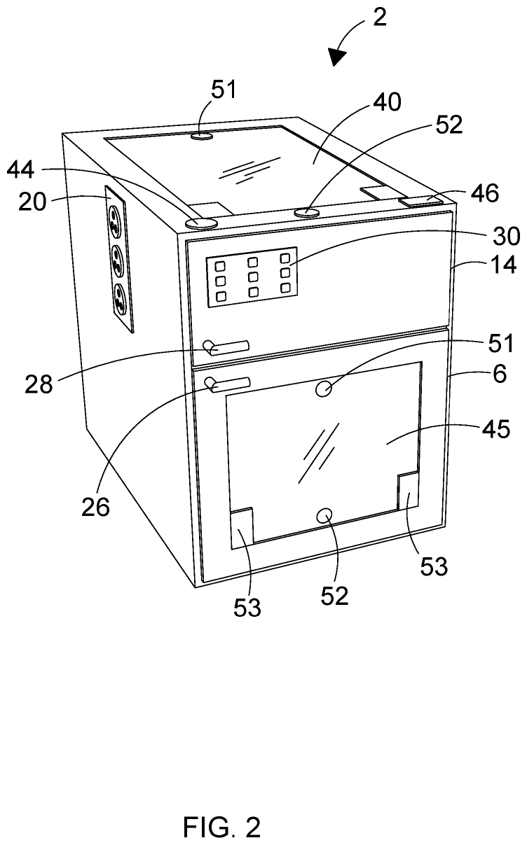

FIG. 2 is the unit of FIG. 1 with the two doors in a closed position; and

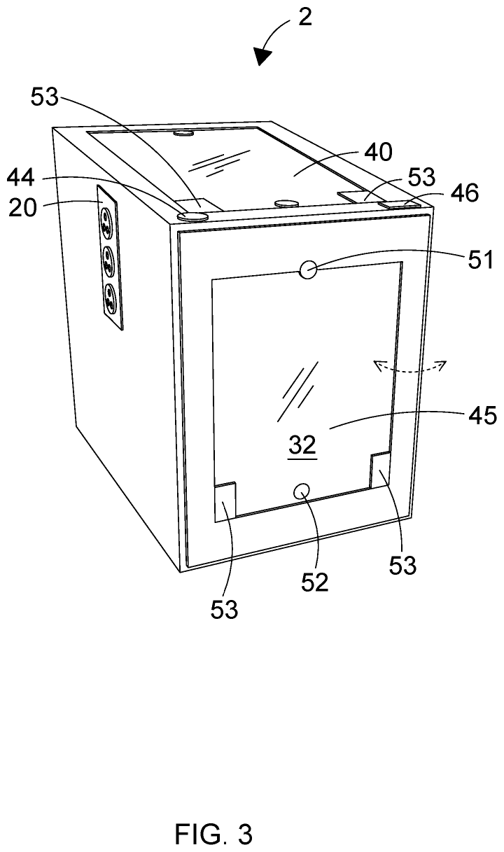

FIG. 3 is a further embodiment to the unit shown in FIG. 2.

Referring to the drawings, FIG. 1 shows a mobile refrigerator unit 2 having a temperature controlled cabinet 4 and a refrigerator door 6 to provide access to the cabinet 4.

The cabinet 4 is in the form of having a floor, three walls and a ceiling, such that the refrigerator door can provide a fourth wall when closed to allow a refrigeration apparatus (not shown) to provide a temperature controlled environment within the cabinet in a manner known in the art. Refrigerator apparatus generally includes at least a condenser, a pump and a heat sink, operating in the manner of the known ‘refrigeration cycle’. The refrigeration apparatus is typically located within one or more enclosures at or near the rear of the refrigerator unit in a manner known in the art.

The refrigerator door 6 provides access to the cabinet 4 when opened, generally full access across one side of the cabinet 4, so as to either add or remove contents therefrom. The contents can include any known or expected goods or items, including food and drinks such as the bottles 8 shown in FIG. 1.

The cabinet 4 could include one or more shelves 10 or other partitions or enclosures, able to help divide or sub-divide the space within the cabinet 4 in a manner known in the art.

Typically, the mobile refrigerator unit 2 provides a controlled temperature of approximately 5° C., or possibly in the range 5° C.-0° C., in a manner known in the art.

FIG. 1 also shows the mobile refrigerator unit 2 further comprising a safe 80. In the example shown in FIG. 1, the safe 80 is located above the cabinet 4, and has a series of distinct walls 12 intended to be wholly or substantially impenetrable for a pre-determined or defined period of time, within the expected standard of the safe. Many safes are defined by certain standards in the art, including ISO standards such as the current 9001 ISO standard, although the present invention is not limited thereto.

In the example shown in FIG. 1, the area of the safe 80 is wholly or substantially defined by the same width and depth as the cabinet 4, such that the cabinet 4 and the safe 80 together define the outer dimensions of the mobile refrigerator unit 2.

Optionally, the cabinet 4 and the safe 80 are formed by sharing at least one side and/or wall.

Alternatively, the cabinet 4 is formed of a series of distinct walls, optionally including a floor and ceiling, and the safe is formed of a series of separate distinct walls, optionally including a floor and ceiling, and the cabinet and safe are brought together, optionally conjoined, to provide the mobile refrigerator unit 2.

FIG. 1 shows the safe 80 including a door 14, moveable between an open position as shown in FIG. 1 and a closed position as shown in FIG. 2, using two hinges 16.

Typically, the safe door 14 provides access to or along one side of the safe 80.

Optionally, the safe door 14 and the refrigerator door 6 provide access to the same facing side of the cabinet and safe, although the skilled man can see that the location of the safe door 14 and the refrigerator door 6 can be so as to provide access on different sides or faces of, or from different directions around, the mobile refrigerator unit 2.

FIG. 1 also shows the mobile refrigerator unit 2 including a panel 20 having a plurality of power or recharging sockets or stations or bases 22. Such power sockets 22 may be the same or different, and may include one or more of the group comprising mains sockets, phone sockets, USB sockets and wireless charging pads.

In this way, the mobile refrigerator unit 2 of the present invention can also provide the user with one or more power sockets suitable for powering one or more other appliances or units, without the need for additional power sources in or around the area being used by the user. Typically, the mobile refrigerator unit 2 is powered from a single source, such as ‘mains power’ using a suitable socket such as a 13 Amp socket in a manner known in the art, such that additional connections within the mobile refrigerator unit 2 can provide power to one or more additional power sockets 22.

Optionally, the panel 20 is integrally formed in the mobile refrigerator unit 2, and may be covered by a suitable door or flap when access to the power sockets 22 is not required.

FIG. 1 also shows the mobile refrigerator unit 2 including a flat upper surface or top 24, which can be used by a user as a suitable working surface to assist with any exhibition stand or display of certain material or goods. An interactive touch screen 40 is integrated into the top surface, the screen 40 preferably having a restricted or narrow viewing angle, provided by way of a privacy filter so that personal and potentially sensitive data can be displayed and entered at the unit, without such data being generally viewable by visitors around the unit.

A further screen 45 is mounted on a front vertical face of the unit and is intended to display relevant material to those in the unit's surroundings. The front screen has a wide viewing angle so that it is visible to a wide audience around the unit.

Each screen may be fixedly mounted in the exterior of the unit, or may be releasably mounted, for example through a lockable docking connection, for removal and storage within the unit when not required. The unit may in this connection have suitable slots within its interior for housing one or more screens when not in use.

The unit may moreover incorporate one or more speakers 53, cameras 51 or microphones 52 enabling the unit to offer video conferencing facilities, or to operate as a public address (PA) system, such speakers, cameras and/or microphones conveniently being part of the one or more screens.

The interface unit includes a wireless charging capability in the form of one or more charging pads or mats 44, where devices to be charged are placed on the pad or through a charging transmitter to charge adjacent devices (not shown).

The interface unit may further comprise a scanner 46 for scanning, for example, QR codes or bar codes on a visitor's pass, or for scanning business cards into an appropriate directory. Consequently, business cards need not be left at the unit, reducing the risk of information theft.

The interface unit may further be linked to a Native App, so that information can be gathered relevant to visitor preferences and hub locations, thereby optimising information displayed on the one or more screens 40, 45.

In this respect a number of such units may be linked together in, for example, an exhibition hall, and the display screens 40, 45 may be configurable to be relevant to information gathered on visitor preferences. For example, the units may gather visitor information so that a particular unit can display a map showing other stands that the visitor may wish to visit. The unit could serve push notifications about offers or companies that might be relevant and could display them on the one or more screens.

FIG. 2 shows the mobile refrigerator unit 2 wherein the refrigerator door 6 and the safe door 14 are in a closed position.

FIG. 2 also shows the refrigerator door having a handle 26. Optionally, the refrigerator door 6 is lockable in its own right, such as having a suitable locking mechanism within or associated with the handle 26.

FIG. 2 shows the safe door 14 having a handle 28 and a keypad 30. The keypad 30 typically includes one or more physical or electronic buttons, to allow a user to enter a pre-defined password or passcode etc. via the buttons, to open the safe door 14. Other locking mechanisms or units may include RF-loops or tags, wireless or Bluetooth units, or a physical key or an electronic tag or key, or similar mechanism, able to work with a complementary mechanism within or close to the safe door 14.

In the case of an electronic tag or key, users of the unit may be issued with unique identifier pass codes, so that data relating to details of access into the safe and/or refrigerator can be logged. Such pass codes can be issued remotely when required and can be programmed to allow access for different people within specific time periods, such as for example the duration of a particular exhibition for an exhibitor, or pre-exhibition for restocking requirements. The unit may transmit such data to a remote location and/or may have local memory for storing such data.

Optionally, the handles 26, 28 and/or the keypad 30 are inset within the general outer dimensions of the mobile refrigerator unit 2.

FIG. 3 shows the unit 2 having an additional outer door 32 able to cover both the safe door 14 and the refrigerator door 6, and able to provide a more desirable outer finishing to the unit 2.

The unit further can include a tracking device (not shown). The tracking device may have any suitable size, shape design, design, and may be overt or covert. The tracking device can be linked to a tracking unit or station, and assist location of the unit should the unit be moved without expectation, e.g. stolen.

The interface unit may also have one or more accelerometers and/or gyro sensors 50 for detecting if the unit is being moved. If movement is detected at a time when this is not anticipated, then a suitable alarm signal and/or notification can be activated. The unit may in this regard have means for programming appropriate moving times and/or status. The status of the interface unit may in this regard be set remotely, so that for example the status of the unit can be moved to an alarmed mode when positioned on a stand, such that unauthorised subsequent movement will activate an alarm signal. In the event of unauthorised movement, the one or more cameras 51 and/or microphones on the unit may be activated to record.

1. A mobile interface unit comprising at least one temperature controlled cabinet, a refrigerator door to provide access to the cabinet, and refrigeration apparatus to provide refrigeration to the cabinet, the unit further comprising a safe and one or more display screens.

2. A unit as claimed in claim 1, wherein at least one of the one or more display screens is a touch screen.

3. A unit as claimed in claim 1, wherein one of the one or more display screens is provided on a substantially horizontal surface of the unit.

4. A unit as claimed in claim 3, wherein the display screen includes a privacy filter.

5. A unit as claimed in claim 1, wherein one of the one or more display screens is provided on a substantially vertical surface of the unit.

6. A unit as claimed in claim 1, further comprising a wireless charging facility provided on the exterior of the unit.

7. A unit as claimed in claim 1, further comprising a scanner.

8. A unit as claimed in claim 1, further comprising a wireless transmitter/receiver for connecting the unit with a local network.

9. A unit as claimed in claim 1 further including one or more power or recharging sockets, stations or bases.

10. A unit as claimed in claim 9, wherein the one or more power or recharging sockets include one or more single phase 13 amp power sockets and/or one or more USB ports.

11. A unit as claimed in claim 1, further including a tracking device.

12. A unit as claimed in claim 1 further comprising one or more accelerometers and/or gyro sensors for detecting movement of the unit.

13. A unit as claimed in claim 1, further comprising any one or more of speaker, camera or microphone means.

14. A unit as claimed in claim 1, further comprising an audible and/or visual alarm.

15. A unit as claimed in claim 14, further comprising alarm control means for activating said alarm on detection of movement of the unit above a threshold level.

16. A unit as claimed in claim 1, wherein the safe is wholly or substantially located within the cabinet.

17. A unit as claimed in claim 1, wherein the safe has a lockable safe door separate to the refrigerator door, to provide access to the safe.

18. A unit as claimed in claim 1 wherein the safe has defined walls separate from the cabinet.

19. A unit as claimed in claim 1, wherein the safe is wholly or substantially separate from the cabinet.

20. A unit as claimed in claim 19, wherein the safe has a lockable safe door separate to the refrigerator door, to provide access to the safe.

21. A unit as claimed in claim 19 or claim 20, wherein the safe and the cabinet are housed in an outer housing.

22. A plurality of units according to claim 1, linked together to share visitor preference information, the one or more display screens on said units being configurable to display information relevant to the visitor preferences.
